(19) United States
(12) Patent Application Publication
(10) Pub. No.: US 2016/0325481 A1
(43) Pub. Date: Nov. 10, 2016

(54) METHOD AND DEVICE FOR DETECTING BROKEN PLASTIC STRANDS OF PLASTIC EXTRUDER BY HEAT

(71) Applicant: TIANJIN KINGFA ADVANCED MATERIALS CO., LTD., Tianjin (CN)

(72) Inventors: Dong LI, Tianjin (CN); Zhimin CHEN, Tianjin (CN); Jingxi ZHANG, Tianjin (CN); Wenliang QI, Tianjin (CN); Wei LIU, Tianjin (CN); Guoxiong CHEN, Tianjin (CN)

(73) Assignee: Tianjin Kingfa Advanced Materials Co., Ltd., Tianjin (CN)

(21) Appl. No.: 15/109,575

(22) PCT Filed: Dec. 30, 2014
(86) PCT No.: PCT/CN2014/095488

§ 371 Date: Jul. 1, 2016

(30) Foreign Application Priority Data
Jan. 3, 2014 (CN) 201410003744.9

(51) Int. Cl. B29C 47/92

(52) U.S. Cl. CPC B29C 47/92; B29C 2947/92295; B29C 2947/92209; B29C 2947/92361

(57) ABSTRACT

The present invention discloses a method and device for detecting broken plastic strands of plastic extruder by heat. In this method, a detection strip is placed below the die exit of plastic extruder. The detection strip is made of a material that is the same as the product being produced by the plastic extruder or a material with similar melting performance as the product being produced. In the event of a broken strand during production, the broken strand will hang down and fall on said detection strip, where the residual heat in the strand can heat the detection strip to over its glass transition temperature and change it from glassy state to elastomeric state until it is pulled or molten to break. Once the break of the detection strip is detected, the alarm will be turned on. The detection device comprises a detection strip, a strip support, a contact detector(s) and a sound-light alarming device. One end of the strip support applies a pre-load upward or downward on the detection strip. The present invention is simple in structure, easy to configure to realize saved labor cost, improved product quality and reduced loss and waste. Thus, it has very promising prospects to be applied widely.

### BACKGROUND OF THE INVENTION

1. Technical Field

The present invention relates to the field of plastic extrusion and granulation, especially a method and device for detecting broken plastic strand of plastic extruder by heat.

2. Description of Related Art

So far, in the process of plastic extrusion and granulation, due to the effects of instable properties of raw materials, inhomogeneous mixing materials and process fluctuations, the abnormal conditions such as broken strands often occur. When a break of strand occurs during production, if the operator fails to find and tackle with such abnormal cases in time, this broken strand will further affect other strands and then form a large block finally. Thus, it will not only influence the production, but waste materials and increase the costs of labor, resource and production.

In order to detect such strand breakage at the earliest time and inform the operator in time, some alarming devices for broken strands have already been proposed so far. These alarming devices employ different detection means such as IR, pressure sensor or conductive rod. Although these means are feasible in principle, they are not suitable very much to the production, which is complex in process and poor in operating conditions, such as plastic extrusion and granulation. Therefore, they are not applied widely.

The exiting alarming devices for detecting broken strands during plastic extrusion and granulation mainly have the following three shortcomings: (1) Either IR detection or pressure sensor detection has such problems as poor anti-interference ability, unreliable system and tending to false alarming due to accidental operation or detection failure. (2) IR detection, pressure sensor and conductive rod are all precise detection devices and expensive. Thus, they are very susceptible to be damaged during cleaning and not practical to be used in plastic granulation. (3) The pressure sensor and conductive rod are both contact detection devices that are very susceptible to be damaged by plastic condensation and cannot be recycled, resulting in rise of use cost finally.

### BRIEF SUMMARY OF THE INVENTION

The main purpose of the present invention is to smooth away the shortcomings and defects of the existing techniques and provide a method for detecting broken plastic strand of plastic extruder by heat. This method is based on simple materials, low in cost, easy to realize and good in monitoring performance. Thus, it shows promise to be widely applied.

The other purpose of the present invention is to provide a detection device based on said method for detecting broken plastic strand of plastic extruder by heat. This device is simple in structure and easy to configure. In the case of a broken strand, it can sound an alarm automatically with good monitoring performance and good prospects to be widely applied.

The purpose of the present invention is realized through the following technical solutions: a method for detecting broken plastic strand of plastic extruder by heat that includes the following steps:

(1) Place the detection strip device below the die exit of plastic extruder, where said strip is made of a material that is the same as the product being produced by the plastic extruder or a material with similar melting performance as the product being produced,

(2) In the event of a broken strand during production, the broken strand will hang down and fall on said detection strip, where the residual heat in the strand will heat the detection strip to over its glass transition temperature and change it from glassy state to elastomeric state until it is pulled or molten to break,

(3) Once the break of the detection strip is detected, the alarming will be turned on.

Furthermore, said detection strip is fixed on the strip support and at least one end of the strip support is compressed or tensioned with a pre-load. Thus, in the case that the detection strip changes to elastomeric state, it is easier to be pulled to break.

Specifically, there is a locking device on one end of said strip support and a tension device on the other end and one end of a spring is fixed on the terminal of the tension device and the other end of the spring is fixed on the strip support, the spring is tensioned during normal detection.

Moreover, in said Step (3), the procedure to test whether the detection strip is broken or not is as follows: in the event of a detected break of the detection strip, the tension device whose terminal normally contacts only one of the two contact detectors installed on the side of the strip support during normal detection, changes to connect with both contact detectors by the spring force due to spring reset and, hence, forms a contact loop with a sound-light alarming device to turn on alarming

A device for detecting broken plastic strand of plastic extruder by heat, comprising a detection strip, a strip support and two contact detectors and sound-light alarming device where the detection strip is made of a material that is the same as the product being produced by the plastic extruder or a material with similar melting performance as the product being produced, the strip support comprises a locking device and a tension device where two ends of the detection strip during normal operation are respectively fixed on the locking device and the tension device, the latter applies a pre-load upward or downward on the detection strip which is below the die exit of plastic extruder and the end of the tension device only contacts one contact detector, in the event that a broken strand hangs down to fall on the detection strip, the detection strip will be molten or pulled to break, then the tension device is moved by the pre-load, so as to allow the tension device to contact with both contact detectors and form a contact loop with the sound-light alarming device. Thus, in the case of a broken strand, the device can automatically alarm with sound and light.

Preferably, said strip support is installed on two sides of the upper part of a water tank and the distance between the detection strip and the water surface in the tank is 5 mm˜150 mm. After the detection strip is molten to break, it will fall into the water tank directly, hence avoiding the dangers of burns and improving the safety of device.

Moreover, said distance is 10 mm˜30 mm.

Preferably, the terminal of said tension device is fixed with a spring and the other end of the spring is fixed on the strip support. This spring is tensioned during normal detection.

Compared with the existing technologies, the present invention has following advantages and beneficial effects:

1. It is simple in structure and easy to configure. In the case of broken strand, it can alarm automatically to remind the operator to follow up and handle in time. Thus, it not only can improve the product yield and productivity as well as save the labor cost for monitoring, but also enhance product quality, reduce loss and waste. Therefore, this invention is promising with good prospect to be widely applied.

2. The method according to the present invention is highly stable. The two contact detectors will be connected to trigger alarming only in the case that the detection strip is molten to break by the residual heat of the broken strand. Thus, this avoids faulty alarming.

3. In the present invention, the detection strip and the strip support easy to be touched by operator cannot be damaged easily, so it has strong practicability.

4. The detection strip used in the present invention can be made of the material being produced. Therefore, it can be taken directly from the strand being produced to allow a low cost of use. Moreover, even if the detection strip is broken or mixed within the product being produced, no quality trouble will be caused.

### BRIEF DESCRIPTION OF THE SEVERAL VIEWS OF THE DRAWINGS

FIG. 1 is the structural diagram of the device according to the present invention.

Where: 1 is Detection strip, 2 is Locking device, 3 is Tension device, 4 is Contact detector, 5 is Spring and 6 is Water tank.

### DETAILED DESCRIPTION OF THE INVENTION

Now, the following embodiment and the drawings are described to further introduce the present invention in detail. Nevertheless, the way of implementation of the present invention is not limited to them.

### Embodiment 1

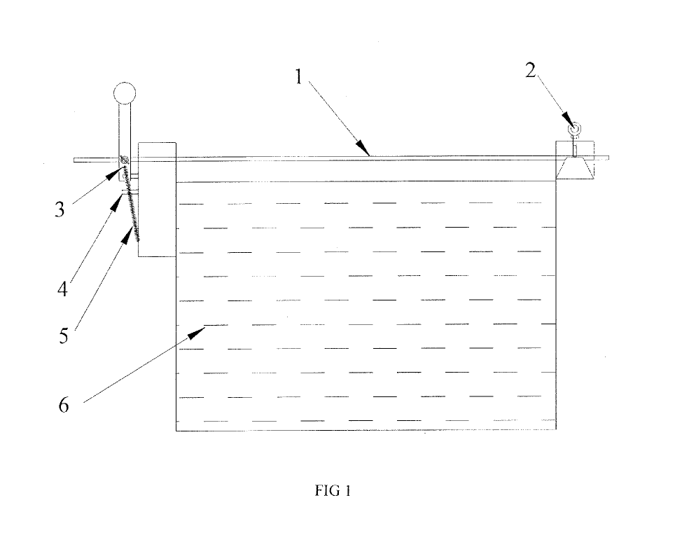

The method and device for detecting broken plastic strand of plastic extruder by heat in this embodiment is one auxiliary detection method and device applied in the processes of plastic extrusion and granulation. The concrete structure of the device is as shown in FIG. 1. As the Figure shows, it includes the detection strip 1, the strip support, two contact detectors 4 and the sound-light alarming device. The detection strip is made of a material that is the same as the product being produced by the plastic extruder or a material with similar melting performance as the product being produced; the strip support include the locking device 2 and the tension device 3. Before the detection is started, two ends of the detection strip 1 are respectively fixed on the locking device 2 and the tension device 3. There is a spring 5 installed on the tension device used to measure the pre-load applied upward or downward on the detection strip 1. The detection strip 1 is below the die exit of extruder. The terminal of the tension device 3 contacts with one of the contact detector 4; in the case that a broken strand hangs down from the die exit of extruder to fall on the detection strip 1, the detection strip 1 will be molten or pulled to break, then the tension device 3 will be moved by the pre-load so as to contact with both contact detectors 4 and hence form a contact loop with the sound-light alarming device.

In the embodiment, the spring is tensioned during normal operation. The broken strand falls from the die exit of extruder on the detection strip 1, which is then is molten to break. Then the tension device 3 is moved downward by the pre-load of the spring to allow spring reset.

In the embodiment, the strip support is installed on the upper part of the water tank 6 and the locking device 2 and the handle tension device 3 are respectively installed on two sides of the water tank. The distance between the detection strip 1 and the water surface in the water tank 6 is 30 mm. In the practical application, this distance can be adjusted based on comprehensive consideration of the size of water tank and the temperature of broken strand, etc.

In the embodiment, the detection strip can be made of a material that is the same as the product being produced by the plastic extruder or a material with similar melting performance as the product being produced. It can be PP or PS materials. Said “similar melting performance” herein refers to that the detection strip can be molten or pulled to break by the residual heat of broken strand. If the melting performance of the detection strip is too strong to be molten, it will fail to realize the purpose of detection. On the contrary, if it is too weak, there will be a possibility that the strip also tends to alarm in the case that other material rather than broken strand contacts it.

In the embodiment, the purpose of locking device is to fix one end of the detection strip, where it can be applied with a pre-load or not. For a device without pre-load, a device such as ordinary bolt or clamping plate can be used as the locking device. For a device with pre-load, on the basis of the above-mentioned device, an extra spring can be added which is at pulled or compressed state to allow the detection strip to be more easily to be pulled apart at elastomeric state. Similarly, the operator can also use a cam structure with spring to tension it through changing the orbital radius of the strip. In the same way, the purpose of the tension structure in the embodiment is to fix one end of the detection strip, meanwhile, also to apply a pre-load upward or downward on the detection strip, i.e. tension. Many such tension devices based on the existing technologies can be utilized, such as the cam mechanism with spring to tension through changing the orbital radius of the detection strip.

The method employed in the embodiment is, before the extruder starts to pull plastic strand for granulation, fix the detection strip on the strip support with the locking device and tension device laterally below the die exit of the extruder. In the case of a broken strand during production, the broken strand will firstly hang down to fall on the detection strand laterally positioned which will continuously absorb heat from the broken strand and be heated to over its glass transition temperature and the form of the detection strip also changes from glassy state to elastomeric state. During this course, the tensile force bearable on the cross-section of the detection strip gets lower and lower until the detection strip is pulled to break by the tension device on the side of water tank connected with the spring. Then the spring resets and hence pulls the tension device to form a contact loop with both contact detectors installed on the sidewall of the strip support. Then the sound-light alarming device in this loop is turned on to sound the alarm.

In practical application, when the sound-light alarming device alarms, an air scissors can be controlled to cut off the detection strip automatically. It can also allow the operator to handle the abnormal situation of broken strand once find the sound-light alarming to avoid a large block of material and production interruption. After the operator clears away the exceptions, a new detection strip can be installed on the strip support by the locking device and the handle tension device to continue monitoring.

The aforementioned embodiment is a preferred one according to the present invention. However, the way of implementation of the present invention is not limited by this embodiment. Any change, modification, substitution, combination and/or simplification without deviating from the spirit and principle of the present invention shall all be deemed as an equivalent replacement of the present invention and shall be covered by the protection scope of the present invention.

What is claimed is:

1. A method for detecting broken plastic strand of plastic extruder by heat, characterized in that it comprises the following steps:
(1) Place the detection strip device below the die exit of plastic extruder, where said strip is made of a material that is the same as the product being produced by the plastic extruder or a material with similar melting performance as the product being produced,
(2) In the event of a broken strand during production, the broken strand will hang down and fall on said detection strip, where the residual heat in the strand will heat the detection strip to over its glass transition temperature and change it from glassy state to elastomeric state until it is pulled or molten to break,
(3) Once the break of the detection strip is detected, the alarming will be turned on

2. The method for detecting broken plastic strand of plastic extruder by heat according to claim 1, characterized in that: said detection strip is fixed on a strip support that is compressed or tensioned with a pre-load on at least one end.

3. The method for detecting broken plastic strand of plastic extruder by heat according to claim 1, characterized in that: there is a locking device on one end of said strip support and a tension device on the other end, and one end of a spring is fixed on the terminal of the tension device and the other end of the spring is fixed on the strip support, the spring is under tension state during normal detection.

4. The method for detecting broken plastic strand of plastic extruder by heat according to claim 1, characterized in that: in said Step (3), the procedure to test whether the detection strip is broken or not is as follows: in the event of a detected break of the detection strip, the tension device whose terminal normally contacts only one of the two contact detectors installed on the side of the strip support during normal detection, changes to connect with both contact detectors by the spring force due to spring reset, hence forms a contact loop with a sound-light alarming device to turn on alarming.

5. A device for detecting broken plastic strand of plastic extruder by heat, characterized in that: it comprises a detection strip, a strip support and two contact detectors and a sound-light alarming device, where the detection strip is made of a material that is the same as the product being produced by the plastic extruder or a material with similar melting performance as the product being produced, the strip support comprises a locking device and tension device where two ends of the detection strip during normal operation are respectively fixed on the locking device and the tension device, the latter applies a pre-load upward or downward on the detection strip which is below the die exit of plastic extruder and the end of the tension device contacts one contact detector, in the event that a broken strand hangs down to fall on the detection strip, the detection strip will be molten or pulled to break, then the tension device is moved by the pre-load so as to allow the tension device to contact with both contact detectors and then form a contact loop with the sound-light alarming device.

6. A device for detecting broken plastic strand of plastic extruder by heat according to claim 5, characterized in that: said strip support is installed on both sides of a water tank and the distance between the detection strip and the surface of water in water tank is 5 mm˜150 mm.

7. A device for detecting broken plastic strand of plastic extruder by heat according to claim 6, characterized in that: said distance is 10 mm˜30 mm.

8. The method for detecting broken plastic strand of plastic extruder by heat according to claim 5, characterized in that: the terminal of said tension device is fixed with a spring, of which the other end is fixed on the strip support and the spring is tensioned during normal detection.
